(19) United States
(12) Patent Application Publication
(10) Pub. No.: US 2015/0267538 A1
(43) Pub. Date: Sep. 24, 2015

(54) STEAM TURBINE WITH RESONANCE CHAMBER

(71) Applicant: ALSTOM Technology Ltd, Baden (CH)

(72) Inventor: Timothy Stephen RICE, Warwickshire (GB)

(21) Appl. No.: 14/662,531

(22) Filed: Mar. 19, 2015

(30) Foreign Application Priority Data
Mar. 24, 2014 (EP) 14161231.7

(51) Int. Cl. F01D 5/10; F01D 5/06; F01D 5/30

(52) U.S. Cl. CPC F01D 5/10; F01D 5/30; F01D 5/06; F05D 2220/31; F05D 2240/24

(57) ABSTRACT

A steam turbine with a resonance chamber in the outer annulus opposite a rotating blade row. The resonance chamber provides passive resonance to place the excitation at a frequency away from the natural frequency of the blades.

### CROSS-REFERENCE TO RELATED APPLICATIONS

This application claims priority to European application 14161231.7 filed Mar. 24, 2014, the contents of which are hereby incorporated in its entirety.

### TECHNICAL FIELD

The present disclosure relates generally to steam turbine and more specifically for system to reduced steam turbine blade vibration.

### BACKGROUND

Turbine blades, because of their complex design, can suffer from vibration at frequencies which correspond to natural frequencies of the blades called modes. Each mode is associated with a different type of vibration such as along the rotational axis of the turbine, perpendicular to the rotational axis of the turbine, etc. To prevent excessive vibration of the blade about its normal position, normal design practice dictates that the blades are constructed such that those modes are located between harmonics of the operating frequency of the steam turbine. However, manufacturing tolerances, changes in blade attachment to the rotor, changes in blade geometry due to erosion and changes in the operating frequency of the turbine, among other factors, cause mode frequencies to approach harmonics of the operating frequency. Additionally, damaging nonsynchronous vibration may also occur. Typically, nonsynchronous vibration in a steam turbine may occur as a result of buffeting wherein a low steam flow and a high back pressure cause the random excitation of the turbine blades or as a result of turbine rotor torsional stresses.

While various methods of suppressing vibration are known including magnetic coupling as discussed in U.S. Pat. No. 4,722,668, fluid injection as discussed in US Pat App No. 2013/0'280050 A1 and blade tuning as discussed in U.S. patent application Ser. No. 4,878,810 there is nonetheless a need for alternative vibration prevention methods.

### SUMMARY

A steam turbine blade vibration suppression system is disclosed.

It attempts to addresses this problem by means of the subject matters of the independent claims. Advantageous embodiments are given in the dependent claims.

The disclosure is based on the general idea of locating a passive resonator, such as a Helmholtz resonator axially above the rotating part of the blade so as to change the excitation frequency.

An aspect provides a steam turbine with a rotor and a circumferentially distributed row of rotating blades extending radially from a root attached to the rotor to a tip portion. An outer annulus circumferentially encloses the row of rotating blades. The steam turbine further includes a resonance chamber having an opening in a region of the outer annulus defined by a radial projection of the root of the blades onto the outer annulus opposite a tip region of the blades. These locations enable the resonator to change the excitation frequency of the blade row.

An aspect comprises a plurality of circumferentially distributed resonance chambers.

In an aspect the resonance chamber is preferably configured for a frequency between 2.5 to 6 engine orders and more preferably for a frequency between 3 to 5 engine orders.

In an aspect, the resonance chamber is configured as a Helmholtz resonator.

In an aspect the steam turbine is a multi-stage steam turbine having a downstream last stage wherein the row of blades where the opening of the resonance chamber is located is last stage blades. The steam turbine may be a low pressure steam turbine configured to operate with an exhaust pressure of at or below ambient pressure.

It is a further object of the invention to overcome or at least ameliorate the disadvantages and shortcomings of the prior art or provide a useful alternative.

Other aspects and advantages of the present disclosure will become apparent from the following description, taken in connection with the accompanying drawings which by way of example illustrate exemplary embodiments of the present invention.

### BRIEF DESCRIPTION OF THE DRAWINGS

By way of example, an embodiment of the present disclosure is described more fully hereinafter with reference to the accompanying drawings, in which:

FIG. 1 is a schematic view of a steam turbine of a preferred embodiment having a resonance chamber; and

FIG. 2 is a schematic of the steam turbine of FIG. 1 with a Helmholtz resonator.

### DETAILED DESCRIPTION

Exemplary embodiments of the present disclosure are now described with references to the drawings, wherein like reference numerals are used to refer to like elements throughout. In the following description, for purposes of explanation, numerous specific details are set forth to provide a thorough understanding of the disclosure. However, the present disclosure may be practiced without these specific details, and is not limited to the exemplary embodiment disclosed herein.

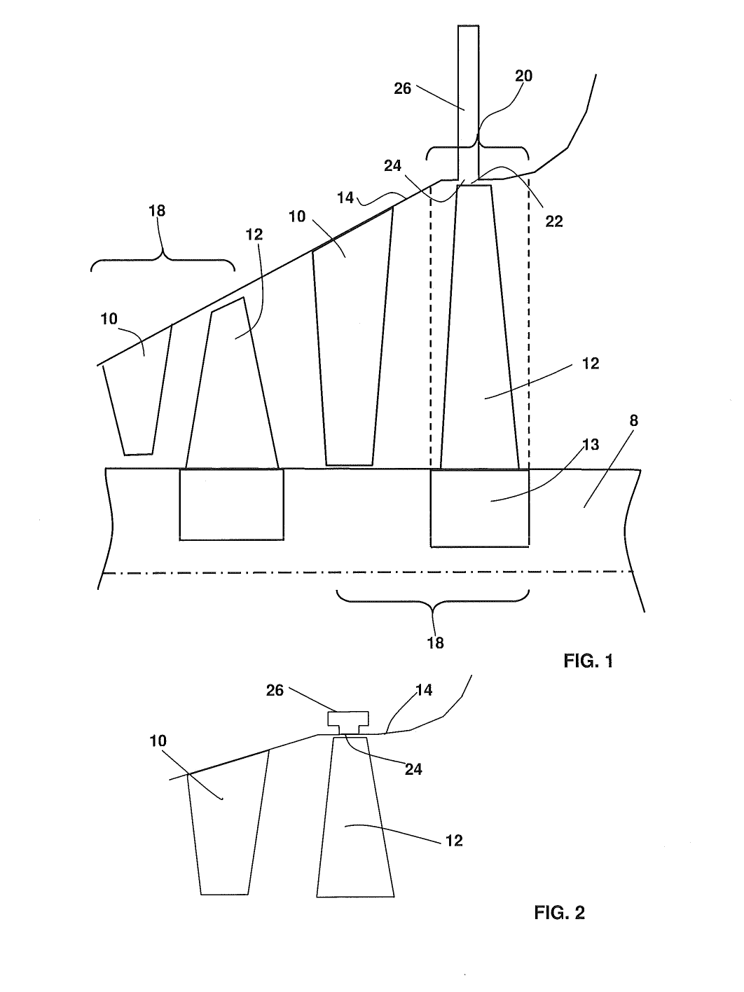

In an exemplary embodiment, as shown in FIG. 1 comprises a steam turbine have a rotor 8, a circumferentially distributed rotating row of blades 12 extending radially from a root 13, attached to the rotor 8 to a tip portion 22, and an outer annulus 14 circumferentially enclosing the row of blades 12 to form an outer annulus 14. A stage 18 of the steam turbine is defined as a combination of a stationary row of vanes 10 and a rotating row of blades 12. Such a steam turbine is may be used for power generation.

In an exemplary embodiment shown in FIG. 1 is a multi-stage steam turbine, wherein the last stage 18 is defined as the downstream stage of the multi-stage 18 steam turbine.

In an exemplary embodiment, the steam turbine is a low pressure steam turbine defined by having an exhaust pressure at or below ambient pressure.

An exemplary embodiment, shown in FIG. 1 includes a resonance chamber 26 having an opening 24 in the outer annulus 14 in a region of the annulus 14 defined by a radially projection 20 of the roots 13 of the blades 12 on to the annulus 14. In another exemplary embodiment the opening 24 is opposite the tip region 22 of the blades 12.

A resonance chamber 26 is defined as an enclosed space with opening having an interior surface which is configured to reflect pressure waves therein. Waves entering the chamber bounce back and forth within the chamber with low loss. The material of the chamber, particularly that of the actual internal walls, its shape and the position of the opening, as well as the finish (porosity) of the internal walls contributes to the dampening effect of the resonance chamber. In exemplary embodiments the resonance chamber 26 may take any form known the art capable of performing the function of a resonance chamber 26 including a Helmholtz resonator 26 shown in FIG. 2.

It has been found that, in particularly for last stage blades of low pressure turbines, a particularly advantages tuning frequency of the resonance chamber is between 2.5 and 6 engine orders, and more particularly between 3 to 5 engine orders.

Although the disclosure has been herein shown and described in what is conceived to be the most practical exemplary embodiment, it will be appreciated by those skilled in the art that the present disclosure can be embodied in other specific forms. The presently disclosed embodiments are therefore considered in all respects to be illustrative and not restricted. The scope of the disclosure is indicated by the appended claims rather that the foregoing description and all changes that come within the meaning and range and equivalences thereof are intended to be embraced therein.

What is claimed:

1. A steam turbine comprising:
a rotor;
a circumferentially distributed rotating row of blades extending radially from a root attached to the rotor to a tip portion;
an outer annulus circumferentially enclosing the row of blades; and
a resonance chamber having an opening in a region of the outer annulus defined by a radial projection of the root of the blades onto the outer annulus.

2. The steam turbine of claim 1 wherein the opening is opposite a tip region of the blades.

3. The steam turbine of claim 1 comprising a plurality of circumferentially distributed resonance chamber.

4. The steam turbine of claim 1 wherein the resonance chamber is configured for a frequency between 2.5 to 6 engine orders.

5. The steam turbine of claim 4 wherein the resonance chamber is configured for a frequency between 3 to 5 engine orders.

6. The steam turbine of claim 1 wherein the resonance chamber is configured as a Helmholtz resonator.

7. The steam turbine of claim 1 wherein the steam turbine is a multi-stage (18) steam turbine having a downstream last stage wherein the row of blades are last stage blades.

8. The steam turbine of claim 1 wherein the steam turbine is a low pressure steam turbine configured to operate with an exhaust pressure at or below ambient pressure.
